(19) United States
(12) Patent Application Publication
(10) Pub. No.: US 2019/0030503 A1
(43) Pub. Date: Jan. 31, 2019

(54) HOLLOW CHAMBER X-MIXER HEAT EXCHANGER

(71) Applicant: BASF SE, Ludwigshafen am Rhein (DE)

(72) Inventors: Faissal-Ali EL-TOUFAILI, Ludwigshafen am Rhein (DE); Cornelia KERMER, Ludwigshafen am Rhein (DE); Cecile MULLER-WEITZEL, Ludwigshafen am Rhein (DE); Gledison FONSECA, Ludwigshafen am Rhein (DE)

(21) Appl. No.: 16/072,076

(22) PCT Filed: Jan. 27, 2017
(86) PCT No.: PCT/EP2017/051811

§ 371 Date: Jul. 23, 2018

(30) Foreign Application Priority Data
Jan. 29, 2016 (EP) 16153383.1

(51) Int. Cl. B01F 15/06; F28D 7/10; F28D 7/12; F28F 1/12; B01F 5/06

(52) U.S. Cl. CPC B01F 15/066; F28D 7/106; F28D 7/12; F28F 2215/08; B01F 5/0619; F28F 2215/06; F28F 1/128

(57) ABSTRACT

A mixer heat exchanger insert or mixer heat exchanger insert arrangement, and a mixer heat exchanger with a corresponding mixer heat exchanger insert arrangement, which have improved mixing and temperature-control behavior, and have a reduced fouling tendency.

### FIELD OF THE INVENTION

The present invention relates to a mixer heat exchanger and to a mixer heat exchanger insert arrangement for a mixer heat exchanger, in particular a mixer heat exchanger and a mixer heat exchanger insert arrangement for a mixer heat exchanger with reduced fouling behavior.

### BACKGROUND OF THE INVENTION

For the mixing of fluids, in particular during processes, both static and dynamic mixers can be used. In the case of dynamic mixers, it is possible, for example, to use stirring elements, which actively stir the fluid to be mixed. In the case of a static mixer, mixing is achieved not through stirring energy introduced externally, but through the energy which is inherent to a flowing fluid. Here the fluid is mixed as a result of the movement of the fluid upon contact with a mixer geometry. For such mixing by means of a static mixer, so-called X mixers, for example, are used, in which structures that are arranged in alternation transversely with respect to one another are introduced in the flow volume and mix a fluid that is flowing though. Such so-called X mixers can, for example, consist of a plurality of bar-shaped flat bodies which, for example, are arranged in alternation at an angle of, for example, 90° with respect to one another. A through-flowing fluid is, in this manner, split and recombined several times, leading to a laminar or turbulent flow, or else forced to change direction, resulting in a turbulent flow which subsequently leads to a mixing of the fluid.

Since mixers of this type are often used in reactors, it is additionally necessary not only to mix the fluid but also at the same time to control the temperature of the fluid. Mixer heat exchangers consisting of several tubes through which a temperature control liquid can be carried are known for this purpose. These pipes, which generally run in the longitudinal direction of a flow channel, are in this case provided with flow guide plates arranged transversely thereto, which bring about mixing of the through-flowing fluid due to the “split and recombine” effect.

Furthermore, heat exchangers are known in which the tubes carrying a temperature control fluid are routed in a meandering manner, with the meandering tubes lying in a plane which lies parallel to the through-flow direction of the fluid in a flow channel.

Mixers and heat exchangers of the type mentioned above are known, for example, from EP 1 067 352 A2 or WO 2008/017571 A1.

The aforementioned heat exchangers and mixers have only a low mixing capacity or, in particular in the case of fluids which have agglomerates, exhibit a tendency for accumulation of agglomerates in regions with acute angles in which the agglomerates or thickened fluid lumps can become lodged, or have flow-calmed regions in which secondary reactions can occur, the products of which can likewise accumulate. This effect is referred to as “fouling”.

Fouling of such type possibly has an adverse effect on the state of the fluid to be mixed and temperature-controlled, so that a settling of agglomerates or thickened fluid lumps should be avoided.

### SUMMARY OF THE INVENTION

An object of the invention may be regarded as that of providing a mixer heat exchanger and a mixer heat exchanger insert or a mixer heat exchanger insert arrangement, which have a reduced fouling tendency.

The object of the present invention is achieved by the subject matter of the independent claims, with developments of the invention being embodied in the dependent claims.

According to an embodiment of the invention, a mixer heat exchanger insert is provided, comprising a first group of hollow-body plates with an inner volume and a second group of hollow-body plates with an inner volume, the hollow-body plates of the first group being inclined in a first direction in relation to a direction of longitudinal extent of the mixer heat exchanger insert, the hollow-body plates of the second group being inclined in a second direction in relation to a direction of longitudinal extent of the mixer heat exchanger insert, the hollow-body plates of the first group laterally abutting the hollow-body plates of the second group and the inner volumes of the first hollow-body plates being connected to the inner volumes of the second hollow-body plates, so that the inner volumes of the first group and the inner volumes of the second group are part of a connected, total inner volume that is designed to carry a temperature control fluid.

In this way, a mixer heat exchanger insert can be provided which at the same time also provides, as flow guide structures, structures through which a temperature control fluid can be carried. In other words, the structures of the mixer heat exchanger insert serve at the same time as flow guide structures for homogenizing and carrying a temperature control liquid. This in particular eliminates the need for a mixing structure, known for example from EP 1 067 352 A1, in which tubes provided in the longitudinal direction of a flow channel which serve for carrying a temperature control fluid are provided and are additionally penetrated by flow guide plates lying transversely thereto. It is possible, in particular, to avoid agglomerates and thickened fluid lumps settling at the joints between the flow channels of the temperature control fluid and the flow deflection plates, since there is no need for such connections in the case of the mixer heat exchanger insert according to the invention. Such a mixer heat exchanger (insert) or mixer heat exchanger insert arrangement also has a significantly better surface-to-volume ratio in comparison to the mixer heat exchangers described in EP 1 067 352 A1. In particular, the surface-to-volume ratio of the arrangement according to the invention can be higher than that in the arrangement described in EP 1 067 352 A1 by a factor of four.

According to an embodiment of the invention, the first direction and the second direction are diametrically opposite one another.

In this way, it is possible, in the case of an alternating impingement of flow on hollow-body plates inclined in the first direction and on hollow-body plates inclined in the second direction, to bring about a splitting of the fluid flow or else a strong alternating flow deflection, which leads to thorough mixing.

According to an embodiment of the invention, the mixer heat exchanger insert further has a temperature control fluid inlet and a temperature control fluid outlet, a hollow-body plate of the second group laterally abutting at least two hollow-body plates of the first group and, at the two abutment points, the inner volume of the hollow-body plate of the second group being connected to the volumes of the two adjacent hollow-body plates of the first group in such a manner that a temperature control fluid flows via the inner volume of a first hollow-body plate of the first group from the temperature control fluid inlet into the inner volume of the hollow-body plate of the second group, and then via the inner volume of the second hollow-body plate of the first group to the temperature control fluid outlet.

In this way, a structure can be provided in which the temperature control liquid flows in an alternating manner through the hollow-body plates which are alternately inclined in a first direction and a second direction. This particularly enables thorough mixing to be achieved by means of the alternately inclined hollow-body plates, while at the same time the temperature control liquid can also flow in a sequential manner through these hollow-body plates. Here it should be understood that the liquid region of the temperature control fluid which is carried through the individual hollow-body plates is hermetically sealed with respect to an outer region, in which a liquid to be temperature-controlled and to be mixed is carried, so that no unwanted mixing of a liquid to be temperature-controlled and to be mixed and the temperature control liquid occurs.

According to an embodiment of the invention, the hollow-body plates of the first group and the hollow-body plates of the second group are of rib-shaped design, a plurality of rib-shaped hollow-body plates of the first group being arranged at intervals next to one another in a parallel manner in the direction of longitudinal extent and a plurality of rib-shaped hollow-body plates of the second group being arranged at intervals next to one another in a parallel manner in the direction of longitudinal extent, the rib-shaped hollow-body plates of the first group arranged next to one another in a parallel manner and the rib-shaped hollow-body plates of the second group arranged next to one another in a parallel manner being arranged next to one another in a mutually abutting and alternating manner and the inner volumes of the respective rib-shaped hollow-body plates being connected to one another at abutment points.

In this way, several flow channels that are flowed through in a parallel manner can be provided for a temperature control liquid in the hollow-body plates, so that, for example, a temperature control liquid in the mixer heat exchanger insert can be carried in the channels in a mutually independent manner. It is possible, in particular, for two rib-shaped hollow-body plates to be inclined in a first direction and two rib-shaped hollow-body plates to be inclined in the second direction, and for these to be arranged in an alternating manner with respect to one another. Here it should be understood that, in case only a single connected inner volume is to be provided, the rib-shaped hollow-body plates can be connected to one another at all abutment points in such a manner that their inner volumes are each connected to one another. By arranging several such combinations of rib-shaped hollow-body plates, it is possible to provide a stack in which the rib-shaped hollow-body plates are arranged one behind the other in the flow direction.

According to an embodiment of the invention, the mixer heat exchanger insert has a third group of hollow-body plates, the hollow-body plates of the third group being inclined in a third direction in relation to a direction of longitudinal extent of the mixer heat exchanger insert, with the first direction, the second direction and the third direction each being arranged at an angle of 120° with respect to one another.

In this way, a type of propeller arrangement can be achieved by the hollow-body plates arranged in an inclined manner, which plates allow particularly thorough mixing of the fluid to be temperature-controlled and to be mixed.

According to an embodiment of the invention, the inclination angle of the hollow-body plates of the first group in relation to the direction of longitudinal extent and the inclination angle of the hollow-body plates of the second group in relation to the direction of longitudinal extent are equal.

In this way, it is possible to achieve a uniform arrangement of the mutually oblique hollow-body plates, which repeatedly give rise at regular intervals to a flow deflection or a splitting of the fluid to be temperature-controlled and to be mixed, so that a uniform, alternating flow deflection or flow split ensues due to the matching inclination angle in opposing directions.

According to an embodiment of the invention, the hollow-body plates form at least two fluidically separate, parallel total volumes over the direction of longitudinal extent.

This can be achieved, in particular, by the connections of the inner volumes of the hollow-body plates of the first group and of the hollow-body plates of the second group being connected at some abutment points while remaining separate at other points, so that the two fluidically separate, parallel total volumes form. As a result of this, a mixer heat exchanger insert can be provided in which the temperature control liquid flows outwards through one total volume and is carried back via the other total volume, so that the inlet and the outlet of the temperature control liquid can be provided on the same side.

According to an embodiment of the invention, the hollow-body plates of the first group, positioned one under the other, and the hollow-body plates of the second group, positioned one under the other, have a matching spacing in the direction of longitudinal extent of the mixer heat exchanger insert.

In this way, it is possible to achieve that the effective flow cross sections at the parallel intermediate spaces are uniformly configured with regard to a through-flow in the longitudinal direction, so that no artificial bottlenecks form in which a build-up of a liquid to be temperature-controlled can possibly occur. Such a build-up can, for example, lead to an agglomeration or thickening of a liquid to be temperature-controlled and to be mixed, which, in turn, can speed up the fouling process.

According to an embodiment of the invention, the hollow-body plates of the first group and the hollow-body plates of the second group are inclined at an angle of 30° to 60°, in particular at an angle of between 40° and 50°, in relation to the direction of longitudinal extent.

In this way, a good ratio can be set between shearing behavior and flow-calmed regions, so that for the liquid to be temperature-controlled, sufficient mixing is ensured.

According to an embodiment of the invention, the mixer heat exchanger insert is manufactured by a 3D printing process, in particular by an additive production process, in particular by a direct metal-melt laser process (DMLS).

In this way, a mixer heat exchanger insert having a complex structure can be manufactured, the hollow-body plates of which insert are connected at the abutment points in such a manner that the inner volumes of mutually abutting hollow-body plates are connected to one another. A 3D printing process allows complicated production of the individual components and joining of the individual components, for example through soldering or welding, to be avoided, so that a mixer heat exchanger insert according to the invention can be manufactured efficiently and cost-effectively.

According to an embodiment of the invention, a mixer heat exchanger insert arrangement having a plurality of mixer heat exchanger inserts according to the description above is provided, the plurality of mixer heat exchanger inserts being arranged one behind the other with respect to a direction of longitudinal extent and a temperature control fluid outlet of a mixer heat exchanger insert being connected to a temperature control fluid inlet of an adjacent mixer heat exchanger insert in such a manner that the inner volumes are connected at a boundary between two adjacent mixer heat exchanger inserts, so that a temperature control fluid can flow from a mixer heat exchanger insert to an adjacent mixer heat exchanger insert.

In this way, several mixer heat exchanger inserts can be arranged one behind the other in a modular manner. In particular, individual mixer heat exchanger inserts can be produced and, according to requirements, joined to each other in a modular manner. This joining together can be realized, for example, by a welding process, a soldering process or a bonding process. As a result of this, it is possible to ensure at the same time that no leakages with respect to the outer volume, in which the fluid to be temperature-controlled and to be mixed is located, occur at the corresponding temperature control fluid inlets and outlets. It is also possible, however, for several mixer heat exchanger inserts to be printed integrally one behind the other.

According to an embodiment of the invention, the mixer heat exchanger inserts arranged one behind the other are arranged in a rotationally offset manner, in particular with a 90° offset, with respect to the direction of longitudinal extent.

In this way, despite a laminar flow being present, it is possible to achieve the desired mixing of the fluid to be temperature-controlled and to be mixed through the offset arrangement of the mixer heat exchanger inserts and thus also of the hollow-body plates or rib-shaped hollow-body plates.

According to an embodiment of the invention, the hollow-body plates form four fluidically separate, parallel total volumes over the direction of longitudinal extent, the parallel total volumes being connected at one end of the mixer heat exchanger insert arrangement in such a manner that a first and a second of the total volumes are flowed through in a parallel manner with respect to one another by a temperature control liquid and subsequently a third and a fourth of the total volumes are flowed through in a parallel manner with respect to one another and in an anti-parallel manner with respect to the first and the second total volumes.

This can ensure that, even in the case of a mixer heat exchanger insert arrangement consisting of a plurality of mixer heat exchanger inserts, a temperature control fluid inlet and a temperature control fluid outlet can be arranged on the same side, the temperature control liquid being able to flow outwards and then back again with respect to the direction of longitudinal extent.

According to an embodiment of the invention, a mixer heat exchanger is provided having a fluid-carrying volume with a fluid inlet and a fluid outlet, and a mixer heat exchanger insert as described above or a mixer heat exchanger insert arrangement as described above, the mixer heat exchanger insert or the mixer heat exchanger insert arrangement extending into the fluid-carrying volume, so that a fluid flowing through the fluid inlet into the fluid-carrying volume experiences a shear stress due to the geometry of the mixer heat exchanger insert or of the mixer heat exchanger insert arrangement, before the fluid that has flowed in exits the fluid-carrying volume through the fluid outlet.

In this way, a mixer heat exchanger can be provided that ensures reliable temperature control of a fluid to be mixed and to be temperature-controlled and, at the same time, enables sufficient mixing of the fluid.

According to an embodiment of the invention, the fluid-carrying volume has a constant internal cross-sectional area over the direction of longitudinal extent.

In this way, dead or build-up spaces can be avoided and a mixer heat exchanger insert arrangement can, for the purpose of installation, be pushed into the fluid-carrying volume in the longitudinal direction. Constant cross section means that, without an inserted mixer heat exchanger insert, the volume has an unchanging cross-sectional area over a longitudinal extent. Here, an inserted mixer heat exchanger insert can however lead to effective flow cross sections which are no longer strictly constant over the longitudinal extent.

According to an embodiment of the invention, an envelope of the mixer heat exchanger insert as described above has a cross-sectional area that corresponds to the constant internal cross-sectional area of the fluid-carrying volume of the mixer heat exchanger, into which volume the mixer heat exchanger insert is to be introduced.

In this way, accurately-fitted joining together of fluid volume and mixer heat exchanger insert arrangement can be achieved. Expansive empty volumes situated parallel to the mixer heat exchanger insert arrangement can likewise be avoided.

The individual features described above can, of course, also be combined with one another, whereby in some cases it is even possible to achieve advantageous effects which go beyond the sum of the individual effects.

These and other aspects of the present invention are explained and illustrated by reference to the exemplary embodiments that are described hereinafter.

### BRIEF DESCRIPTION OF THE FIGURES

Exemplary embodiments are described below with reference to the following drawings.

FIG. 1 shows an exemplary embodiment of a mixer heat exchanger insert.

FIG. 2 shows a half-section view of a part of a mixer heat exchanger insert according to an exemplary embodiment of the invention.

FIG. 3 shows a mixer heat exchanger insert having a single connected inner volume according to an exemplary embodiment of the invention.

FIG. 4 shows a mixer heat exchanger insert having four inner volumes arranged in a parallel manner according to an exemplary embodiment of the invention.

FIG. 5 shows an outer view of a mixer heat exchanger insert arrangement having a plurality of mixer heat exchanger inserts arranged one behind the other in the longitudinal direction.

FIG. 6 shows a section view of a mixer heat exchanger insert arrangement according to FIG. 5.

FIG. 7 shows a diagrammatic view of a mixer heat exchanger insert arrangement according to FIG. 5.

FIG. 8 shows a mixer heat exchanger according to an exemplary embodiment of the invention.

FIG. 9 shows a mixer heat exchanger insert arrangement for a bidirectional temperature control liquid through-flow according to an exemplary embodiment of the invention.

FIG. 10 shows a plan view in the longitudinal direction of the temperature control fluid inlet and outlet from FIG. 9.

FIG. 11 shows a detailed section view of the structure of a temperature control fluid inlet and outlet shown in FIG. 9.

FIG. 12 shows a partial section exposure of a mixer heat exchanger according to an exemplary embodiment of the invention.

FIG. 13 shows a diagrammatic view of the flow channels with respect to the rib-shaped hollow-body plates.

FIG. 14 shows a diagrammatic arrangement of a mixer heat exchanger insert having a first, a second and a third group of hollow-body plates that are arranged at an angle of 120° with respect to one another.

FIG. 15 shows a diagrammatic view of the channel route of a mixer heat exchanger insert arrangement having two separate inner volumes.

FIG. 16 shows a diagrammatic view of a mixer heat exchanger insert arrangement having four separate inner volumes and the corresponding flow directions of a temperature control fluid.

### DETAILED DESCRIPTION OF EXEMPLARY EMBODIMENTS

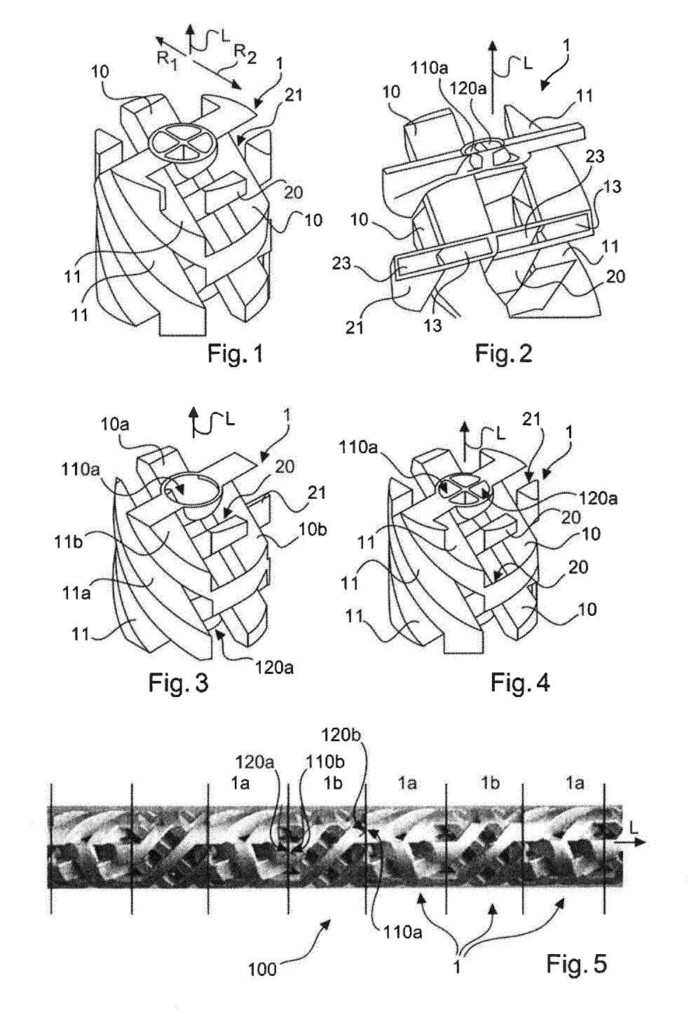

FIG. 1 shows a mixer heat exchanger insert according to an exemplary embodiment of the invention. In the embodiment shown here, the mixer heat exchanger insert, also referred to below as insert, has a plurality of hollow-body plates 10, 11 of a first group and a plurality of hollow-body plates 20, 21 of a second group. The hollow-body plates of the first group are inclined in one direction, while the hollow-body plates of the second group are inclined in an opposite direction. In the embodiment of FIG. 1 shown here, the inclination direction of the hollow-body plates is opposed and the inclination angle is substantially the same. The different hollow-body plates, which are situated one under the other in an oblique manner in the direction of longitudinal extent L, for example here the hollow-body plates 11, have a matching spacing. It should be understood, however, that the hollow-body plates according to other embodiments can also have different inclination angles and can possibly also have a spacing that varies. All of the embodiments shown in the figures have hollow-body plates, said plates having a substantially planar incident-flow surface. It should be understood, however, that the hollow-body plates can also have curved designs, whereby optimized flow conditions can occur, which can then lead to improved mixing.

It can be seen from FIG. 1 that the first group has the hollow-body plates 10 situated one under the other and the hollow-body plates 11 respectively situated one under the other, while the second group has the hollow-body plates 20 situated one under the other and the hollow-body plates 21 respectively situated one under the other. The hollow-body plates of the first group and the hollow-body plates of the second group are respectively arranged in an alternating manner, so that a cross-shaped arrangement of the hollow-body plates ensues. The hollow-body plates each have an inner volume which, however, is not visible in FIG. 1 on account of the closed representation.

FIG. 2 shows a partial-section view of a mixer heat exchanger insert according to an exemplary embodiment of the invention. It can be seen through the section view in FIG. 2 that the individual hollow-body plates have an inner volume. In this case, in the embodiment shown in FIG. 2, the inner volumes 13 of the hollow-body plates of the first group 10 or 11 are connected at the abutment points of the hollow-body plates to an inner volume 23 of the hollow-body plates 21, 20 of the second group, so that a temperature control fluid is able to flow from the first hollow-body plate 10 or 11 through the connection at the abutment points from the first volume 13 into the second volume 23 of the second hollow-body plates 20 or 21. In the embodiment shown in FIG. 2, this results in an arrangement in which at least two separate channels arise, which can be flowed through separately from one another. It can also be seen in FIG. 2 that there is a temperature control fluid inlet 110a and a temperature control fluid outlet 120a at the upper end of the mixer heat exchanger insert. In the arrangement shown in FIG. 2, a temperature control fluid, for example, flows through the temperature control fluid inlet 110a into the inner volumes of the hollow-body plates 10 and 21 and, in this case, here flows downwards counter to the arrow of the direction of longitudinal extent. At the end of the mixer heat exchanger insert not shown here, the temperature control liquid can then be deflected into the second channel section, so that the temperature control liquid flows through the inner volumes 13, 23 of the hollow-body plates 20 and 11 upwards again, here in the arrow direction of the axis of longitudinal extent, and exits through the temperature control fluid outlet 120a. In this way, a heat exchanger can be provided which, on account of its configuration of the heat-exchanger hollow bodies, also allows a mixing of a fluid to be temperature-controlled and to be mixed. In terms of functional consistency, the arrangement can also be regarded as a mixer, which has a heat exchanger property due to the hollow-body plate design of the mixer structures.

FIG. 3 shows an exemplary embodiment of a mixer heat exchanger insert 1, having a plurality of hollow-body plates. Here the hollow-body plates of the first group 11, 11a, 11 b are arranged one above the other, just like the hollow-body plates 10 and 10b and analogously also the hollow-body plates 20 and 21. In this context, “one above the other” is also to be understood as meaning “one above the other in an oblique manner”. The mixer heat exchanger insert shown in FIG. 3 is provided in a so-called single-channel arrangement, that is to say, the inner volumes of all of the hollow-body plates represent a total inner volume, so that, starting from the temperature control fluid inlet 110a, a single through-flow channel through the mixer heat exchanger insert 1 ensues and the temperature control liquid can flow out through the temperature control fluid outlet 120a. Here it should be understood that branchings can also occur in the single channel, which do not strictly have to be free of dead ends.

FIG. 4 shows a further exemplary embodiment of a mixer heat exchanger insert 1 which here, however, is designed as a so-called four-channel arrangement. In this case, the hollow-body plates 10, 11, 20, 21 are connected to each other at the respective joints in such a manner that their inner volumes constitute not a single inner volume, but in total four inner volumes. This can be achieved for example by a nested arrangement of the flowed-through hollow-body plates, so that, for example, every second one of the hollow-body plates 11 and every second one of the hollow-body plates 20 form a first channel, and the hollow-body plates 11 and 20 situated in between can form a second channel that is nested therewith. In the same way, every second one of the hollow-body plates 10 and every second one of the hollow-body plates 21 forms a channel, while also the hollow-body plates 10 and 21 situated in between form a further channel, so that in total four channels are provided. These channels can be arranged with respect to one another in such a manner that, for example, a temperature control fluid can flow in through a temperature control fluid inlet 110a, then be distributed between the first two channels, in which channels the temperature control fluid moves downwards counter to the direction of fall of the direction of longitudinal extent L, while the temperature control fluid can, at the bottom, be deflected in such a manner that it flows upwards again through the two further channels and exits through the temperature control fluid outlet 120a.

FIG. 5 shows a side view of a mixer heat exchanger insert arrangement 100 according to an exemplary embodiment of the invention. The mixer heat exchanger insert arrangement, also referred to below as arrangement, has a plurality of inserts 1a, 1 b arranged one behind the other. These inserts 1a, 1b are arranged one behind the other in the longitudinal direction L. As can be gathered from FIG. 5, the inserts are respectively offset by 90° with respect to one another, that is to say arranged rotated through 90° about the longitudinal direction L one behind the other. In this case, the temperature control fluid outlets 120a of a first insert 1a, which outlets although identified here are not visible in detail, are connected to the temperature control fluid inlets 110b of a second insert 1b, giving rise to one continuous channel, or two or four continuous channels, as a result of the arrangement.

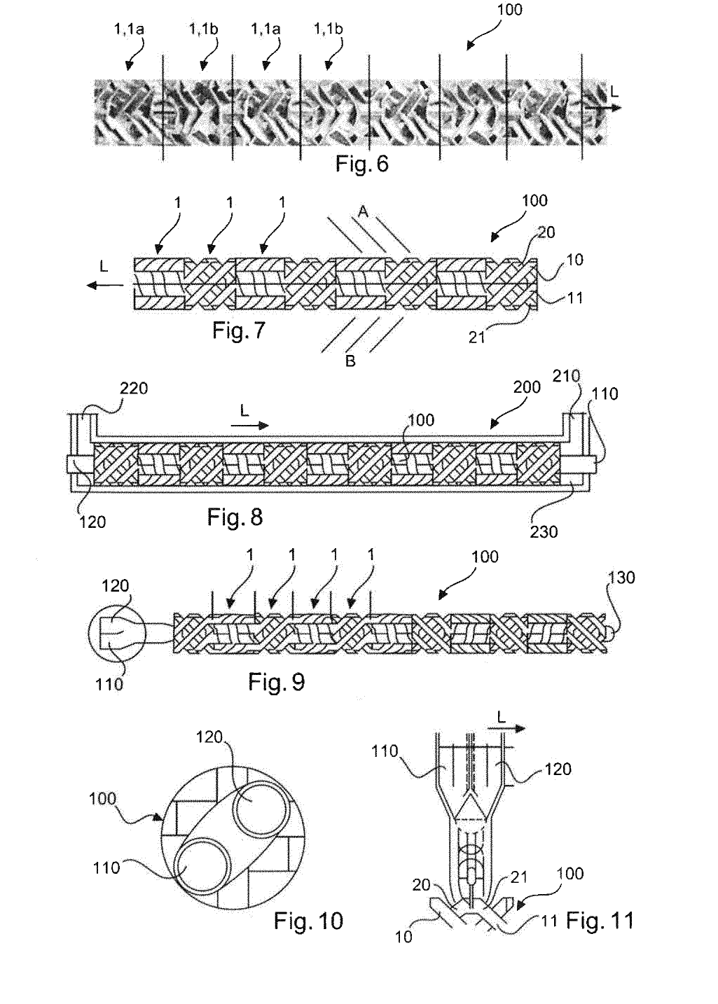

FIG. 6 shows a section view of the arrangement shown in FIG. 5, from which the location of the inner volumes of the individual hollow-body plates can be seen. The scale shown in FIG. 6 corresponds substantially to the scale of FIG. 5. The mixer heat exchanger inserts 1, 1a and 1, 1b are arranged one behind the other in the longitudinal direction L and also in FIG. 6 are rotated in each case through 90° around the longitudinal axis L with respect to one another.

FIG. 7 shows a diagrammatic view of the arrangement shown in FIG. 5, said arrangement comprising a plurality of inserts 1 arranged one behind the other in the longitudinal direction L. Here, by way of example, the arrangement of the hollow-body plates for an insert of the arrangement 100 is numbered with the hollow-body plates 10, 11 of the first group and the hollow-body plates 20, 21 of the second group. Moreover, the position of the inclines of the hollow-body plates is indicated by the reference designations A and B. It can be seen from FIG. 7 that the inclination directions A and B are diametrically opposite one another, the hollow-body plates of the respective groups have substantially matching spacings and the inclination angles of the hollow-body plates of the respective group match.

FIG. 8 shows an exemplary embodiment of a mixer heat exchanger 200, having a fluid-carrying volume 230 and a fluid inlet 210 and a fluid outlet 220. It should be understood that the mixer heat exchanger 200 can be flowed through both in the arrow direction of the direction of longitudinal extent L and in the reverse direction, whereby, in the latter case, the fluid inlet then becomes the fluid outlet and the fluid outlet becomes the fluid inlet. The mixer heat exchanger insert arrangement used in FIG. 8 corresponds substantially to the arrangement described previously. In the arrangement described in FIG. 8, a temperature control fluid inlet 110 is found on the side of the fluid inlet 210, while the temperature control fluid outlet 120 is found on the side of the fluid outlet 220. In the arrangement shown in FIG. 8, the flow direction of the fluid to be temperature-controlled and to be mixed thus matches the flow direction of the temperature control fluid. It is, however, equally possible to operate the mixer heat exchanger 200 in counterflow mode, whereby in this case the flow direction of the fluid to be cooled and to be mixed is opposite to the flow direction of the temperature control fluid and either the temperature control fluid inlet 110 becomes the temperature control fluid outlet or the fluid inlet 210 becomes the fluid outlet. The same applies for the fluid outlets 220 and the temperature control fluid outlet 120, respectively.

FIG. 9 shows an alternative embodiment of a mixer heat exchanger insert arrangement in which, however, the temperature control fluid inlet and the temperature control fluid outlet 110, 120 are arranged not on opposite sides but on one side (on the left in FIG. 9). In this case, the temperature control fluid flows in via the temperature control fluid inlet 110, flows through the individual mixer heat exchanger inserts to the opposite end via at least one channel, and there is deflected via a corresponding coupling piece 130, which is positioned between the separate through-flow volumes, in such a manner that the temperature control fluid flows back to the temperature control fluid outlet 120 through return-flow channels that are separated from the outward flow channel. Here it should be understood that the arrangement shown in FIG. 9 can, for example, have two separate volumes that are connected to one another by the coupling piece 130. Alternatively, the embodiment shown in FIG. 9 can also have four separate inner volumes, which are connected to one another by a corresponding coupling piece 130 at the end in such a manner that two channels serve as the outward-flow channel and two channels serve as the return-flow channel.

FIG. 10 shows an end view of the arrangement 100 shown in FIG. 9, having a temperature control fluid inlet 110 and a temperature control fluid outlet 120.

FIG. 11 shows a section view of an arrangement shown in FIG. 9 in the region of the temperature control fluid inlet and outlet 110, 120. It can be seen from FIG. 11 that the temperature control fluid flowing in via the temperature control fluid inlet 110 flows into the corresponding hollow-body plates 10 and 20, in order to subsequently flow back via the insert or the arrangement, that is not shown further in detail, in order to then reach the temperature control fluid outlet 120 from the hollow-body plates 11, 21.

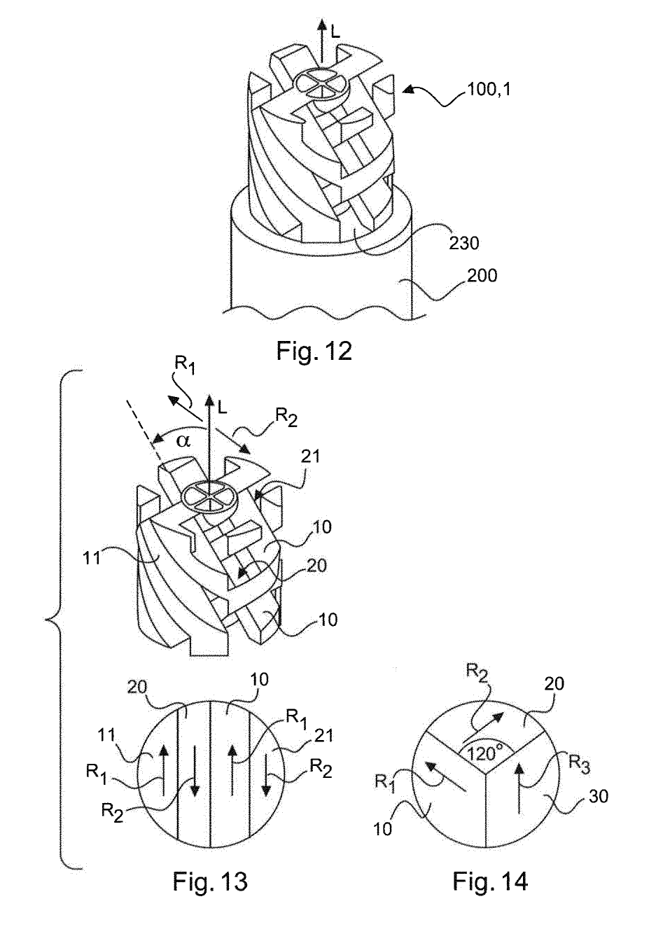

FIG. 12 shows a partial-section view of the arrangement shown in FIG. 8 in which a spatial representation of the four-channel arrangement 100 is illustrated, the latter being found in the fluid-carrying volume 230 of the mixer heat exchanger insert arrangement 200.

FIG. 13 shows an exemplary diagrammatic view of the inclination directions R1 and R2 with respect to the, here rib-shaped, hollow-body plates 10, 11 of the first group and the, here rib-shaped, hollow-body plates 20, 21 of the second group. As can be gathered from FIG. 13, the inclination direction R1 of the hollow-body plates of the first group 10, 11 is consistent, just as the inclination direction R2 of the hollow-body plates of the second group 20, 21 is consistent. In this case, the inclination direction is opposed and the corresponding inclination angle α (alpha) in relation to the axis of longitudinal extent L is the same for both inclination directions R1 and R2.

FIG. 14 shows an alternative embodiment in which hollow-body plates of a first group, hollow-body plates of a second group and hollow-body plates of a third group are provided. In this case, the hollow-body plates of the first group 10 are, in relation to the hollow-body plates 20 of the second group and likewise in relation to the hollow-body plates of the third group 30, offset by 120° and arranged in an inclined manner, so that a propeller-like arrangement ensues as a result of the three hollow-body plates 10, 20, 30 illustrated here and gives rise to thorough mixing of the liquid to be mixed and to be temperature-controlled. It should be understood that several of the hollow-body plates 10 or 20 or 30 can be arranged one behind the other, which cannot be gathered from FIG. 14.

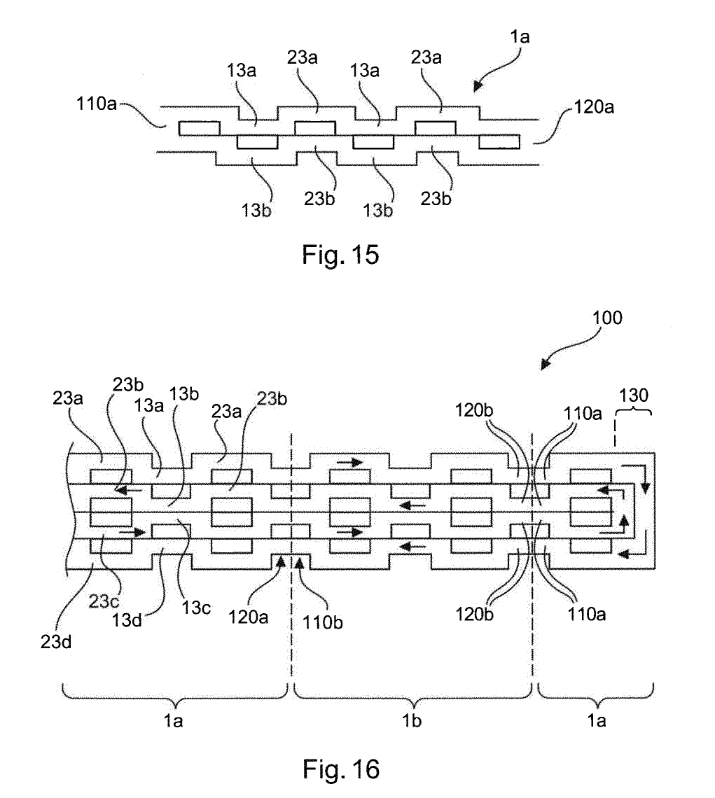

FIG. 15 shows a diagrammatic view of the channel route inside a mixer heat exchanger insert 1a. In this case, for example, the temperature control fluid flows through a temperature control fluid inlet 110a and, in the process, is distributed between the two channel sections, which are identified by the letters a and b. Here, in the upper channel a, a hollow-body plate of the first group with the inner volume 13a and a hollow-body plate of the second group with the inner volume 23a are flowed through in an alternating manner. Analogously, in the second lower channel arrangement, a hollow-body plate of the first group with the inner volume 13b and a hollow-body plate of the second group with the inner volume 23b are flowed through in an alternating manner. Both channels are flowed through in a parallel manner in the arrangement shown in FIG. 15, so that the temperature control fluid inlet 110a and the temperature control fluid outlet 120a are arranged on opposite sides. If, alternatively, the temperature control fluid inlet and the temperature control fluid outlet are arranged on the same side, a coupling piece for the two channels, which is not shown here, can be provided on the side that is remote from the inlet/outlet, said coupling piece connecting the two channels to one another in such a manner that these are flowed through one after the other and not in a parallel manner.

FIG. 16 shows an exemplary embodiment of a mixer heat exchanger insert arrangement, here having a plurality of mixer heat exchanger inserts 1a, 1b arranged one behind the other. Analogously to the channel route in FIG. 15, a channel route with four parallel channels is illustrated in FIG. 16, which are identified here by the lower-case letters a, b, c and d. In FIG. 16, the corresponding flow directions of the temperature control fluid are represented by the arrows. The complete arrangement 100 is sealed off by a coupling 130, which provides a coupling of the first or second channel with a third or fourth channel, or a total volume. In this way, in the embodiment shown in FIG. 16, the channels with the inner volumes 13a, 23a and 13c, 23c are flowed through from left to right and at the end the temperature control fluid is carried back into the corresponding channels with the inner volumes 13b and 23b and 13d and 23d through the coupling piece 130.

It should be noted that the term “comprise” does not exclude further elements or process steps, just as the term “one” or “a” does not exclude a plurality of elements and steps.

The reference designations that are used serve solely to increase understanding and should in no way be regarded as restrictive, with the scope of protection of the invention being rendered by the claims.

List of reference designations:
1, 1a, 1b mixer heat exchanger insert
10, 10a, 10b (rib-shaped) hollow-body plates of the first group
11, 11a, 11 b (rib-shaped) hollow-body plates of the first group
13 inner volume of the hollow-body plates of the first group
13a, b, c, d first/second/third/fourth (total) volume
20 (rib-shaped) hollow-body plates of the second group
21 (rib-shaped) hollow-body plates of the second group
23 inner volume of the hollow-body plates of the second group
23a, b, c, d first/second/third/fourth (total) volume
100 mixer heat exchanger insert arrangement
110 temperature control fluid inlet or outlet of the insert arrangement
110a, b temperature control fluid inlet or outlet of the insert
120 temperature control fluid outlet or inlet of the insert arrangement
120a, b temperature control fluid outlet or inlet of the insert
130 coupling of a first/second total volume with a third/fourth total volume
200 mixer heat exchanger
210 (mixing) fluid inlet or outlet
220 (mixing) fluid outlet or inlet
230 (mixing-)fluid-carrying volume
L direction of longitudinal extent of mixer heat exchanger insert or mixer heat exchanger insert arrangement
R1 inclination direction of the hollow-body plates of the first group
R2 inclination direction of the hollow-body plates of the second group
R3 inclination direction of the hollow-body plates of the third group
α, alpha inclination angle of the hollow-body plates in relation to the direction of longitudinal extent L

1.-16. (canceled)

17. A mixer heat exchanger insert comprising:
a first group of hollow-body plates with an inner volume and
a second group of hollow-body plates with an inner volume,
the hollow-body plates of the first group being inclined in a first direction (R1) in relation to a direction of longitudinal extent (L) of the mixer heat exchanger insert,
the hollow-body plates of the second group being inclined in a second direction (R2) in relation to a direction of longitudinal extent (L) of the mixer heat exchanger insert,
the hollow-body plates of the first group laterally abutting the hollow-body plates of the second group and the inner volumes of the first hollow-body plates being connected to the inner volumes of the second hollow-body plates, so that the inner volumes of the first group and the inner volumes of the second group are part of a connected, total inner volume that is designed to carry a temperature control fluid.

18. The mixer heat exchanger as claimed in claim 17, the first direction (R1) and the second direction (R2) being diametrically opposite one another.

19. The mixer heat exchanger insert as claimed in claim 17, further comprising a temperature control fluid inlet and a temperature control fluid outlet, a hollow-body plate of the second group laterally abutting at least two hollow-body plates of the first group and, at the two abutment points, the inner volume of the hollow-body plate of the second group being connected to the volumes of the two adjacent hollow-body plates of the first group in such a manner that a temperature control fluid flows via the inner volume of a first hollow-body plate of the first group from the temperature control fluid inlet into the inner volume of the hollow-body plate of the second group, and then via the inner volume of a second hollow-body plate of the first group to the temperature control fluid outlet.

20. The mixer heat exchanger insert as claimed in claim 17, the hollow-body plates of the first group and the hollow-body plates of the second group being of rib-shaped design, a plurality of rib-shaped hollow-body plates of the first group being arranged at intervals next to one another in a parallel manner in the direction of longitudinal extent (L) and a plurality of rib-shaped hollow-body plates of the second group being arranged at intervals next to one another in a parallel manner in the direction of longitudinal extent (L), the rib-shaped hollow-body plates of the first group arranged next to one another in a parallel manner and the rib-shaped hollow-body plates of the second group arranged next to one another in a parallel manner being arranged next to one another in a mutually abutting and alternating manner and the inner volumes of the respective rib-shaped hollow-body plates being connected to one another at abutment points.

21. The mixer heat exchanger insert as claimed in claim 17, further comprising a third group of hollow-body plates, the hollow-body plates of the third group being inclined in a third direction (R3) in relation to a direction of longitudinal extent (L) of the mixer heat exchanger insert, with the first direction (R1), the second direction (R2) and the third direction (R3) being arranged at an angle of 120° with respect to one another.

22. The mixer heat exchanger insert as claimed in claim 17, the inclination angle (a alpha) of the hollow-body plates of the first group in relation to the direction of longitudinal extent (L) and the inclination angle (a alpha) of the hollow-body plates of the second group in relation to the direction of longitudinal extent (L) being equal.

23. The mixer heat exchanger insert as claimed in claim 17, the hollow-body plates forming at least two fluidically separate, parallel total volumes over the direction of longitudinal extent.

24. The mixer heat exchanger insert as claimed in claim 17, the hollow-body plates of the first group, positioned one under the other, and the hollow-body plates of the second group, positioned one under the other, having a matching spacing in the direction of longitudinal extent (L) of the mixer heat exchanger insert.

25. The mixer heat exchanger insert as claimed in claim 17, the hollow-body plates of the first group and the hollow-body plates of the second group being inclined at an angle (a alpha) of 30° to 60°, in particular at an angle (a alpha) of between 40° and 50°, in relation to the direction of longitudinal extent (L).

26. The mixer heat exchanger insert as claimed in claim 17, the mixer heat exchanger insert (1) being manufactured by a 3D printing process, in particular by an additive production process, in particular by a direct metal-melt laser process (DMLS).

27. A mixer heat exchanger insert arrangement having a plurality of mixer heat exchanger inserts as claimed in claim 17, the plurality of mixer heat exchanger inserts being arranged one behind the other with respect to a direction of longitudinal extent (L) and a temperature control fluid outlet of a mixer heat exchanger insert being connected to a temperature control fluid inlet of an adjacent mixer heat exchanger insert in such a manner that the inner volumes are connected at a boundary between two adjacent mixer heat exchanger inserts, so that a temperature control fluid can flow from a mixer heat exchanger insert to an adjacent mixer heat exchanger insert.

28. The mixer heat exchanger insert arrangement as claimed in claim 27, the mixer heat exchanger inserts arranged one behind the other being arranged in a rotationally offset manner, in particular with a 90° offset, with respect to the direction of longitudinal extent (L).

29. The mixer heat exchanger insert arrangement as claimed in claim 27, the hollow-body plates forming four fluidically separate, parallel total volumes over the direction of longitudinal extent, the parallel total volumes being connected at one end of the mixer heat exchanger insert arrangement in such a manner that a first and a second of the total volumes are flowed through in a parallel manner with respect to one another by a temperature control liquid and subsequently a third and a fourth of the total volumes are flowed through in a parallel manner with respect to one another and in an anti-parallel manner with respect to the first and the second total volumes.

30. A mixer heat exchanger comprising:
a fluid-carrying volume having a fluid inlet and a fluid outlet, and
a mixer heat exchanger insert as claimed in claim 17 or a mixer heat exchanger insert arrangement as claimed in claim 27, the mixer heat exchanger insert or the mixer heat exchanger insert arrangement extending into the fluid-carrying volume, so that a fluid flowing through the fluid inlet into the fluid-carrying volume experiences a shear stress due to the geometry of the mixer heat exchanger insert or of the mixer heat exchanger insert arrangement, before the fluid that has flowed in exits the fluid-carrying volume through the fluid outlet.

31. The mixer heat exchanger as claimed in claim 30, the fluid-carrying volume having a constant internal cross-sectional area over the direction of longitudinal extent (L).

32. The mixer heat exchanger as claimed in claim 30, an envelope of the mixer heat exchanger insert as claimed in claim 17 having a cross-sectional area that corresponds to the constant internal cross-sectional area of the fluid-carrying volume of the mixer heat exchanger, into which volume the mixer heat exchanger insert is to be introduced.
